(19) United States
(12) Patent Application Publication
(10) Pub. No.: US 2013/0154978 A1
(43) Pub. Date: Jun. 20, 2013

(54) METHOD AND APPARATUS FOR PROVIDING A MULTI-TOUCH INTERACTION IN A PORTABLE TERMINAL

(71) Applicant: SAMSUNG ELECTRONICS CO., LTD., Gyeonggi-do (KR)

(72) Inventors: Seonhwa KIM, Seoul (KR); Jiyoung KANG, Gyeonggi-do (KR); Kyunghwa KIM, Seoul (KR); Dongjun SHIN, Seoul (KR)

(73) Assignee: SAMSUNG ELECTRONICS CO., LTD., Gyeonggi-do (KR)

(21) Appl. No.: 13/716,315

(22) Filed: Dec. 17, 2012

(30) Foreign Application Priority Data
Dec. 19, 2011 (KR) 10-2011-0137241

(51) Int. Cl. G06F 3/041

(52) U.S. Cl. CPC G06F 3/041
USPC 345/173

(57) ABSTRACT

A method of providing a multi touch interaction in a portable terminal includes receiving a first touch input, performing a first function corresponding to the received first touch input, receiving a second touch input when the first touch input is maintained, and performing a second function corresponding to the received second touch input while maintaining a movement of at least one specific object selected by the first touch input.

### CLAIM OF PRIORITY

This application claims the benefit under 35 U.S.C. §119(a) of a Korean patent application filed on Dec. 19, 2011 in the Korean Intellectual Property Office and assigned Serial No. 10-2011-0137241, the entire disclosure of which is hereby incorporated by reference.

### BACKGROUND OF THE INVENTION

1. Field of the Invention

The present invention relates to a method and an apparatus for providing a multi touch interaction, and more particularly, to a method and an apparatus for providing a multi touch interaction in a portable terminal for controlling the portable terminal more conveniently and intuitively.

2. Description of the Related Art

The use and distribution of a portable terminal has rapidly increased due to remarkable development of an information and communication technology and a semiconductor technology. Accordingly, the portable terminal became a necessity in a modern life. In addition to a general communication function such as a voice call or a message service, the portable terminal provides various functions including a TV service function (e.g., mobile broadcasting such as digital multimedia broadcasting (DMB) or digital video broadcasting (DVB)), a music reproducing function (e.g., MPEG Audio Layer-3 (MP3)), a picture photographing function, a data communication function, an internet access function, and a short range wireless communication function.

As the portable terminal supports various functions, a method of controlling the portable terminal more promptly and conveniently is needed. Especially, as more number of portable terminals are implemented with a touch screen, there exists an increasing demand for enhanced user control interface using a touch interaction.

### SUMMARY OF THE INVENTION

The present invention has been made in view of the above problems and provides additional advantages, by providing a method and an apparatus for providing a multi touch interaction in a portable terminal capable of controlling the portable terminal more conveniently and intuitively through a multi touch interaction inputted at different time points.

The present invention further provides a method and an apparatus for providing a multi touch interaction in a portable terminal capable of individually processing a multi touch interaction inputted in a consecutive order.

The present invention further provides a method and an apparatus for providing a multi touch interaction in a portable terminal capable of selecting a specific object through a first touch input and performing a function related to the selected object through a second touch input.

In accordance with an aspect of the present invention, a method of providing a multi touch interaction in a portable terminal includes: receiving a first touch input; performing a first function corresponding to the received first touch input; receiving a second touch input when the first touch input is maintained; and performing a second function corresponding to the received second touch input.

In accordance with another aspect of the present invention, an apparatus for providing a multi touch interaction in a portable terminal includes: a touch panel configured to receive a touch input and a controller configured to perform a first function corresponding to a received first touch input when the first touch input is received from the touch panel and configured to perform a second function corresponding to a received second touch input when the second touch input is received while the first touch input is maintained.

### BRIEF DESCRIPTION OF THE DRAWINGS

The above features and advantages of the present invention will be more apparent from the following detailed description in conjunction with the accompanying drawings, in which:

FIG. 1 is a block diagram illustrating a schematic configuration of a portable terminal according to an exemplary embodiment of the present invention;

FIG. 2 is a detailed view illustrating a controller of a portable terminal according to an exemplary embodiment of the present invention;

FIG. 3 is a flowchart illustrating a method of providing a multi touch interaction of a portable terminal according to an exemplary embodiment of the present invention;

FIGS. 4A and 4B are example screen views illustrating an example of moving an icon in a home screen through a multi touch interaction according to an exemplary embodiment of the present invention;

FIG. 5 is an example screen view illustrating an example of changing an arrangement of an item in a list screen through a multi touch interaction according to an exemplary embodiment of the present invention; and

FIGS. 6A and 6B are example screen views illustrating an example of providing a bookmark function in an electronic book screen through a multi touch interaction according to an exemplary embodiment of the present invention.

### DETAILED DESCRIPTION OF EXEMPLARY EMBODIMENTS

Hereinafter, exemplary embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

It should be noted that a portable terminal according to an exemplary embodiment of the present invention is a device equipped with a touch screen to recognize a multi touch and may be a personal digital assistant (PDA), a mobile communication terminal, a smart phone, a tablet personal computer (PC), a tabletop, a portable multimedia player (PMP), or a laptop. Meanwhile, the present invention may apply to an electronic device having a relatively large screen such as, for example, a large format display (LFD), an electronic blackboard, or a touch monitor.

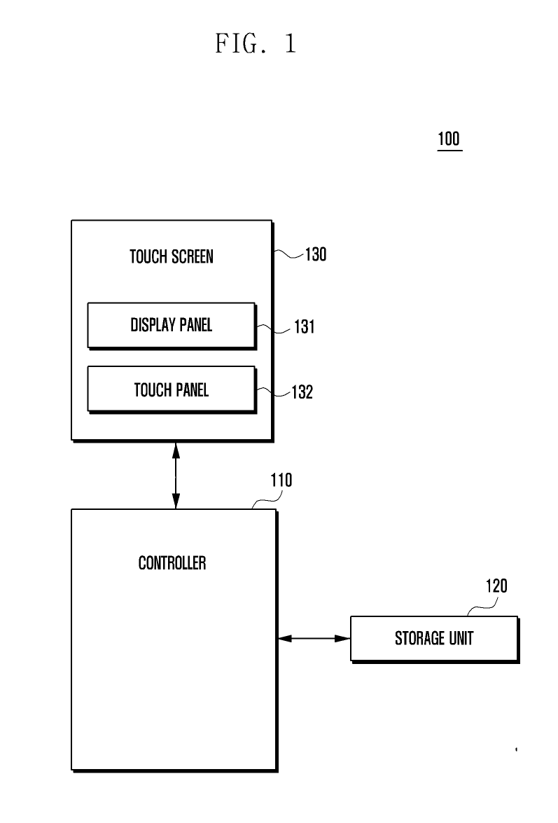

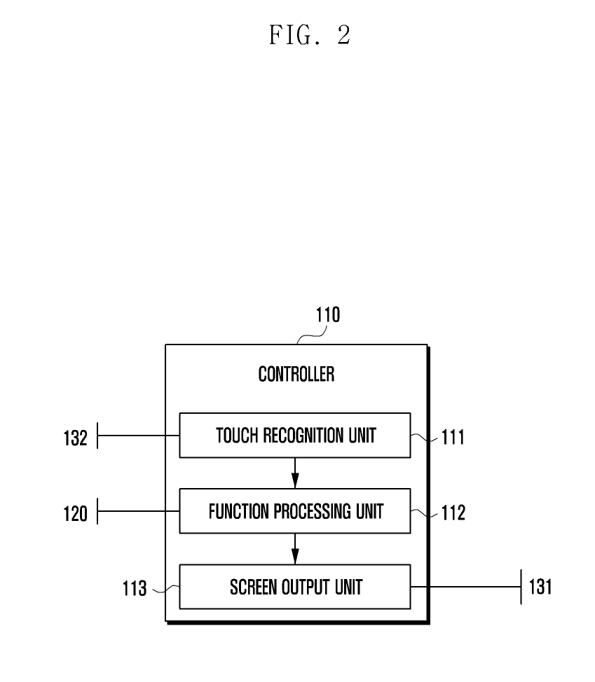

FIG. 1 is a block diagram illustrating a schematic configuration of a portable terminal according to an exemplary embodiment of the present invention, and FIG. 2 is a detailed view illustrating a controller of a portable terminal according to an exemplary embodiment of the present invention.

Referring to FIGS. 1 and 2, a portable terminal 100 according to an exemplary embodiment of the present invention may include a touch screen 130, a storage unit 120, and a controller 110. The touch screen 130 may include a display panel 131 and a touch panel 132, and the controller 110 may include a touch recognition unit 111, a function processing unit 112, and a screen output unit 113.

The touch screen 130 may perform an input function and a display function. To this end, the touch screen 130 may include the display panel 131 and the touch panel 132.

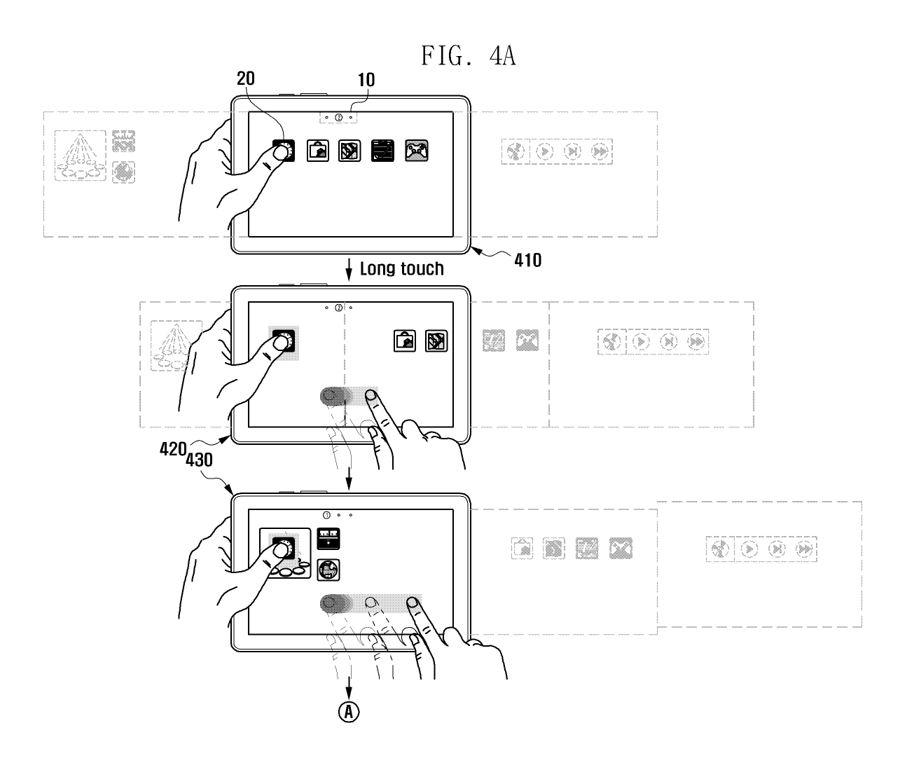

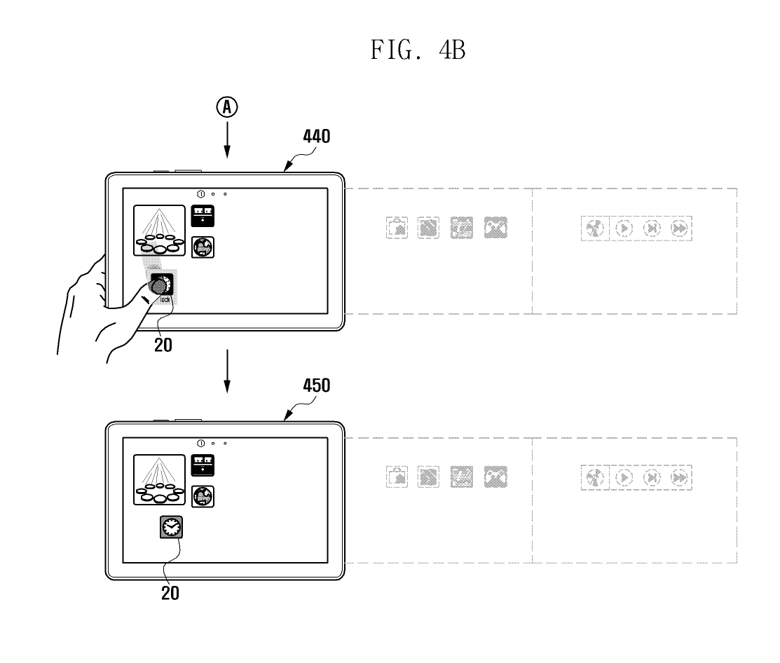

The display panel 131 displays information inputted by a user or information to be provided to the user as well as various menus of the portable terminal 100. For example, the display panel 131 may provide various screens according to use of the portable terminal 100 such as, for example, a home screen page, a message writing screen, a call screen, a list screen, or a content (e.g., electronic book) execution screen. Particularly, the display panel 131 according to the present invention may provide various screens controlled through a multi touch interaction inputted at different time points. A detailed description of the various screens will be made with reference to FIGS. 4A through 6B. The display panel 131 may be formed, for example, in a liquid crystal display (LCD), an organic light emitted diode (OLED), or an active matrix organic light emitted diode (AMOLED).

The touch panel 132 is mounted on a top surface of the display panel 131 and may generate a touch event when a touch input device such as, for example, a user's finger or a stylus contacts thereto and transmit the generated touch event to the controller 110. Specifically, the touch panel 132 may recognize a touch based on a change in a physical quantity, (e.g., a capacitance or a resistance) according to a contact by the touch input device and transmit touch location information to the controller 110. Such touch panel 132 is well known to those skilled in the art, and thus a detailed description thereof will be omitted.

The storage unit 120 may store a program required for operating a function according to an exemplary embodiment of the present invention, a user data, etc. For example, the storage unit 120 may store a program for controlling an overall operation of the portable terminal 100, an operating system (OS) for booting the portable terminal 100, an application programs for an optional function such as, for example, a camera function, a sound reproducing function, an image or video reproducing function, or a short range communication function, and multiple contents. Also, the storage unit 120 may store a key map or a menu map for operating the touch screen 130. Here, the key map and the menu map may be configured in various forms. For example, the key map may be a keyboard map, a 3*4 key map, a QWERTY key map, or a control key map for controlling an operation of an application program that is currently activated. Also, the menu map may be a menu map for controlling an operation of an application program that is currently activated. Particularly, the storage unit 120 according to an exemplary embodiment of the present invention may store an application program for recognizing a multi touch interaction inputted at different time points and controlling an operation of a function of the portable terminal 100 according to the recognized multi touch interaction. The application program may include, for example, a touch recognition routine for recognizing the touch event, a function processing routine for processing a function according to the recognized touch event, and a screen output routine for outputting a screen according to the function processing.

The controller 110 may control an overall operation of the portable terminal 100 and control a signal flow between internal blocks of the portable terminal 100. Particularly, the controller 110 according to the present invention may recognize the multi touch interaction inputted at different time points and control a function thereof. To this end, the controller 110 may include the touch recognition unit 111, the function processing unit 112, and the screen outputting unit 113.

The touch recognition unit 111 may recognize a type of the touch event such as, for example, a touch, touch release, a tap, a double touch, touch movement (e.g., a drag, a flick), a multi touch, based on information inputted from the touch panel 132. Here, the touch indicates a state in which the user's finger or stylus contacts the touch panel 132 and the touch release indicates a state in which a contact to the touch panel 132 by the touch input device is released. A tap event is a touch event in which the touch is released in a certain period of time after the touch is made, the double touch indicates a touch event in which the tap event is consecutively generated, a long touch indicates a touch event in which the touch is maintained during a predetermined time or more, and the touch movement indicates a touch event in which a certain point is touched and the touch is moved to another point. The touch movement may include a drag event that moves at a speed lower than a reference speed and a flick event that moves at a speed equal to or greater than the reference speed. The multi touch indicates a touch event in which at least two touch events are generated. Particularly, the touch recognition unit 111 of the present invention may recognize a multi touch inputted at different time points and transmit the multi touch to the function processing unit 112.

The function processing unit 112 may perform a function corresponding to the touch event recognized by the touch recognition unit 111. Particularly, the function processing unit 112 according to the present invention may perform a first function upon receiving a first touch, and when a second touch is received in a state where the first function is performed, i.e., the first touch is maintained, the function processing unit 112 may perform a second function corresponding to the second touch. Here, the second function may be a function related to the first function executed by the first touch. For example, when a location of an icon included in a home screen needs to be changed, the first touch may be a long touch event that selects the icon and enters into an editing mode, and the second touch may be a touch movement event that requests to output another page of the home screen. Alternatively, when changing an arrangement of an item included in the list screen, a first touch input may be a long touch event that selects the item and enters into the editing mode, and a second touch input may be a touch movement event that scrolls a list. Alternatively, when providing a bookmark function in an electronic book content execution screen, the first touch input may be a long touch event that selects a particular page to which a bookmark is to be added, and the second touch input may be a touch movement event that requests page movement of an electronic book. A detailed description thereof will be described with reference to FIGS. 4A through 6B.

The screen output unit 113 may control a screen output of the display panel 131. The screen output unit 113 may transmit a data corresponding to a function execution screen executed by the function processing unit 112 to the display panel 131. Namely, the screen output unit 113 may control the display panel 131 to output a screen as shown in FIGS. 4A thorough 6B.

Although not shown in FIG. 1, the portable terminal 100 according to the present invention may selectively further include other elements for providing additional functions such as, for example, a camera module for capturing an image or a video, a broadcast receiving module for receiving a broadcast, a digital sound source reproducing module such as an MP3 module, and a proximity sensor module for proximity sensing. With the convergence of digital devices, there may be many digital devices and modifications thereof, not listed in the application, and, it will be appreciated that elements equivalent to the level of the forgoing elements can also be included in the portable terminal 100.

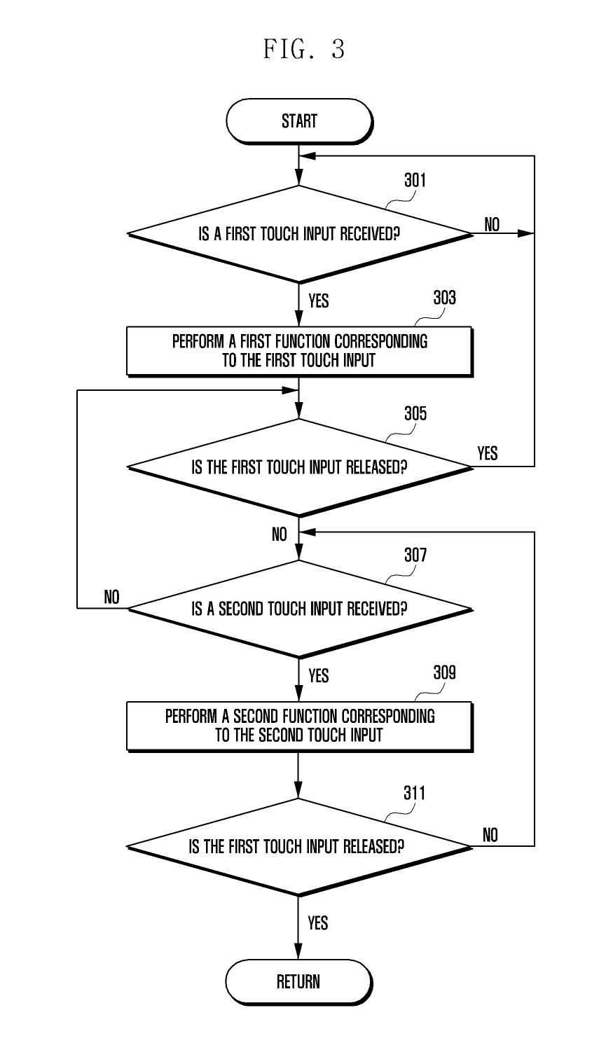

FIG. 3 is a flowchart illustrating a method of providing a multi touch interaction of a portable terminal according to an exemplary embodiment of the present invention.

Referring to FIGS. 1 thorough 3, the controller 110 according to an exemplary embodiment of the present invention may identify whether the first touch input is received (301). When the first touch input is not received, the controller 110 may maintain step 301 in a stand by mode to receive the first touch input. On the other hand, when the first touch input is received, the controller 110 may perform the first function corresponding to the first touch input (303). For example, the touch input may be a long touch event that selects an object, and the first function may be a function of performing the editing mode or adding the bookmark in response to the first touch input. An illustrative detailed description thereof will be made later with reference to example screen views of FIGS. 4A thorough 6B.

Thereafter, the controller 110 may identify whether the first touch input is released (305). When the first touch input is released, the controller may return to step 301. On the other hand, when the first touch input is not released, the controller 100 may identify whether the second touch input is received (307). When the second touch input is not received, the controller 110 may return to step 305. On the other hand, when the second touch input is received, the controller 110 may perform the second function corresponding to the second touch input (309). The second touch input may be a touch movement event, and the second function may be a function related with the first function. Again, an illustrative detailed description thereof will be made later with reference to example screen views of FIGS. 4A thorough 6B.

Next, the controller 110 may identify whether the first input is released (311). When the first touch input is not released in step 311, the controller 110 may return to step 307 and, when the first touch input is released, the controller 110 may return to step 301 to repeat the above process.

Hereinafter, the present invention will be described in more detail through various exemplary embodiments.

FIGS. 4A and 4B are example screen views illustrating an example of moving an icon in a home screen through a multi touch interaction according to an exemplary embodiment of the present invention.

Referring to FIGS. 1 through 4B, the controller 110 according to an exemplary embodiment of the present invention may output a home screen 410. The home screen 410 may include various pages, and each page of the home screen may include a plurality of icons such as, for example, a content icon, a widget icon, a shortcut icon, and a folder icon. Here, an upper portion of the home screen may display a page information indicator 10 for indicating a total number of pages and a current page number. The page information indicator 10 is fixed regardless of movement of a page displayed on the screen. Referring to the page information indicator 10 in the example screen view identified by reference number 410, it can be known that the home screen of the portable terminal 100 includes three pages and a second page is currently outputted. Here, a first page and a third page, which are obscurely displayed in a dotted line, are not shown to the user.

In the example screen view identified by reference number 410, the user may touch (a first touch) a specific icon 20 for a longer period which in turn triggers a location movement event. That is, when the long touch event on the specific icon 20 is received, the controller 110 may perform the editing mode for changing the location of the icon. When the editing mode is triggered, the controller 110 may change the specific icon 20 into a floating state as shown in an example screen view identified by reference number 420 and highlight the specific icon 20 to notify the user that the editing mode is executed.

When the editing mode is executed and a touch movement event (a second touch) requesting to move the screen is inputted from an area other than the touched point, as shown by the right index finger, the controller 110 may perform a screen movement function according to a touch movement direction as shown in an example screen view identified by reference number 420 and finally by an example screen view identified by reference number 430. Here, the specific icon 20 that is floated or held by a left thumb is not moved. As the right index finger moves to right, the content of previous first screen is moved to the current screen. As a result, as shown by screen 430, the icon is moved to the first page of the home screen, and the specific icon 20 no longer exists in the second page.

In a state where a touch on the specific icon 20 is maintained and another page of the home screen is outputted through the touch movement event as described above, when the touch on the specific icon 20 is released, the controller 110 may change a location of the specific item 20 to a location in which the touch is released. For example, as shown in an example screen view identified by reference number 440 and an example screen view identified by reference number 450, the user may move the specific icon 20 to a location the user desires in the first page and release the touch.

Accordingly, through the first touch input that selects the icon of which location is to be moved in the home screen and the second touch input that requests to move to another page of the home screen, the location of the icon included in the original home screen may be easily changed. Note that the second touch input is inputted while the first touch input is maintained.

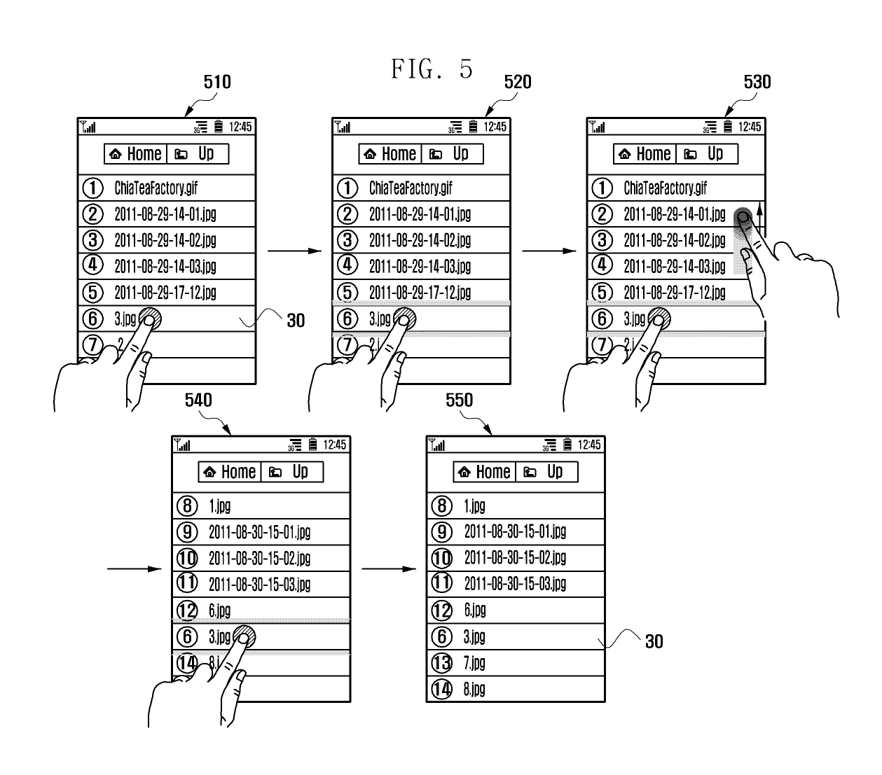

FIG. 5 is an example screen view illustrating an example of changing an arrangement of an item in a list screen through a multi touch interaction according to an exemplary embodiment of the present invention.

Referring to FIGS. 1 through 5, the controller 110 according to an exemplary embodiment of the present invention may output a list screen as shown in an example screen view identified by reference number 510. The list screen may be a screen that outputs a content list such as a music file, a picture file, or a video file. Meanwhile, in the list screen shown in the example screen view identified by reference number 510, a plurality of items is arranged in a vertical direction. However, the present invention is not limited to this. Namely, the present invention may apply to any list screen in which a plurality of items is arranged in at least one of a horizontal direction and a vertical direction, or any combination of directions.

In the example screen view identified by reference number 510, the user may touch (a first touch) a specific item 30 of which arrangement (or location) for a predetermined time or more. When the first touch input is received, the controller 110 may perform the editing mode. When the editing mode is executed, the controller 110 may change the specific item 30 into a floating state as shown in the example screen view identified by reference number 520 and highlight the specific item 30 to notify the user that the editing mode is executed.

In a state where the editing mode being executed, when a touch movement event (a second touch) requesting to move the screen is inputted from an area other than the touched point, the controller 110 may perform a list movement (or scroll) function according to a touch movement direction as shown in an example screen view identified by reference number 530. Here, the touched specific item 30 is not moved, and the controller 110 may output a list screen that is scrolled according to the touch movement event as shown in a screen example view identified by reference number 540.

When the list screen is moved (or scrolled) and the touch on the specific item 30 is released, the controller 110 may change the location of the particular item 30 to a location where the touch is released. Namely, as shown in a screen example view identified by reference number 550, the controller 110 may move the specific item 30 to be between an item “6.jpg” and an item “7.jpg”.

Thus, according to the teachings of the present invention, through the first touch input that selects a specific item in the list and the second touch input that scrolls the list, an arrangement of an item in the list screen may be easily changed. Here, the second touch input is inputted while the first touch input is maintained.

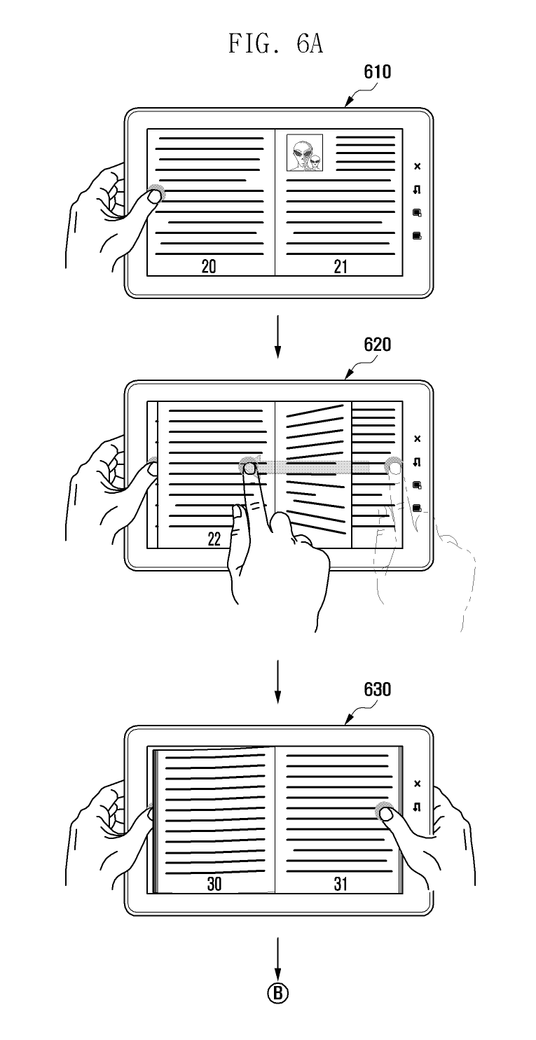

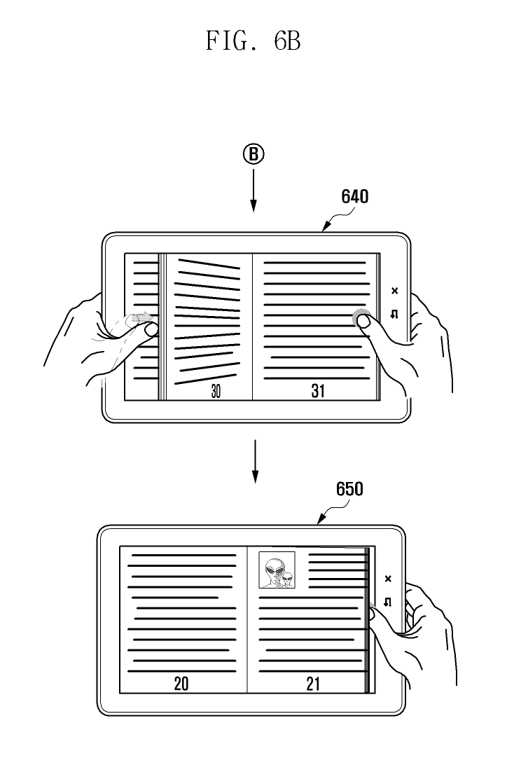

FIGS. 6A and 6B are example screen views illustrating an example of providing a bookmark function in an electronic book screen through a multi touch interaction according to an exemplary embodiment of the present invention.

Referring to FIGS. 1 through 6B, the controller 110 according to an exemplary embodiment of the present invention may execute an electronic book content according to a user request. When the electronic book content is executed, the controller 110 may output an electronic book content execution screen as shown in a screen example view identified by reference number 610.

In the electronic book content execution screen, when one side of a specific page is touched (a first touch), the controller 110 may add a first bookmark to the touched specific page (e.g., page 20). Here, the bookmark may be a temporary bookmark that is deleted when the first touch is released. The temporary bookmark may be stored in the storage unit 120 or a buffer (not shown) included in the controller 110.

In a state where the first touch is maintained, when the touch movement event (a second touch) is generated in the electronic book content execution screen, the controller 110 may perform a page movement function as shown in an example screen view identified by reference number 620. Referring to page information of an example screen view identified by reference number 620 and an example screen view identified by reference number 630, the user may add the first bookmark to the page 20 through the first touch and move the page to output pages 30-31 through multiple touch movement.

After moving to the pages 30-31 according to the touch movement event, when the user touches (a third touch) one side of the page 31 of the electronic book as shown in the example screen view identified by reference number 630, the controller 110 may add a second bookmark to the touched page 31. Note that due to the bookmarking in page 20, the subsequent pages 22 through 30 have been overlaid, thus simulating a real paper book experience.

In the example screen view identified by reference number 630, when a touch movement event that moves the first touch in a right direction as shown in the example screen view identified by reference number 640 is detected, the controller 110 may control to output the page 20 to which the first bookmark is added as shown in an example screen view identified by reference number 650. Thereafter, in the example screen view identified by reference number 650, the first bookmark may be deleted due to release of the first touch. On the other hand, since the third touch is maintained, the second bookmark is not deleted. In other words, in the example screen view identified by reference number 650, when a touch movement event that moves the third touch in a left direction is detected, the controller 110 may control to output the page 31 (in a reverse direction) to which the second bookmark is added on the screen.

Meanwhile, although not shown in FIGS. 6A and 6B, when a first touch release event is inputted in the example screen view identified by reference number 630, the controller 110 may delete the first bookmark, and when a second touch release event is inputted, the controller 110 may delete the second bookmark.

Also, although it is shown in FIGS. 6A and 6B that two pages are outputted on the screen when executing the electronic book content, the present invention is not limited to this. Namely, the portable terminal 100 may output one page or more depending on a screen size.

Also, although it is described in FIGS. 4A, 4B and 5 that one object (icon or an item) is selected by the first touch; however, the present invention is not limited thereto. For example, the user of the portable terminal according to the present invention may enter into the editing mode by performing the long touch on multiple objects in the home screen or the list screen and enter the touch movement event while maintaining the long touch on the multiple objects, thereby moving the screen.

Meanwhile, in the above, the present invention is described with respect to examples of the home screen, the list screen, and the electronic content execution screen. However, the present invention is not limited to these examples. For example, the present invention may enter into the editing mode through a touch (long touch) on an image content (e.g., a photo) and cut a portion area of the image according to a second touch movement event that is inputted on the image content while the touch is maintained. In other words, when only a face needs to be cut from a picture of a whole figure, the user may enter into the editing mode by a touch (long touch) on the picture of the whole figure and cut a face area through the touch movement event corresponding to a gesture that draws a looped curve such as a circle to include a face.

The foregoing method for changing a screen size using a multi-touch of the present invention may be implemented in an executable program command form by various computer means and be recorded in a computer readable recording medium. In this case, the computer readable recording medium may include a program command, a data file, and a data structure individually or a combination thereof. In the meantime, the program command recorded in a recording medium may be specially designed or configured for the present invention or be known to a person having ordinary skill in a computer software field to be used. The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM. RAM, flash memory storing and executing program commands. Further, the program command includes a machine language code created by a compiler and a high-level language code executable by a computer using an interpreter. The foregoing hardware device may be configured to be operated as at least one software module to perform an operation of the present invention.

As described above, in the present invention, by using a multi touch inputted at different time points, a portable terminal may be controlled more conveniently and intuitively. For example, the present invention may individually perform a function of selecting an object (e.g., a specific icon on a home screen, a specific item on a list, or a specific page in an electronic book) and a function of moving a screen through a multi touch. In other words, in the present invention, in a state where the first function is being performed according to a single touch or a multi touch, when a second touch is inputted, a second function may be performed. Namely, compared to the prior art where only one function can be performed at a time, in the present invention, two functions may be performed according to a multi touch input inputted in a consecutive order, thereby improving user convenience.

As described above, in a method and an apparatus for providing a multi touch interaction of a portable terminal according to an exemplary embodiment of the present invention, a portable terminal may be controlled more conveniently and intuitively by using a multi touch inputted at different time points. For example, in the present invention, a first function may be performed through a first touch input and, when the first function is being executed, a second function may be performed through a second touch input. Accordingly, the present invention may improve user's experience and convenience.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of providing a multi touch interaction in a portable terminal having a touch screen, the method comprising:
detecting a first touch input;
performing a first function corresponding to the detected first touch input;
detecting a second touch input while the first touch input is maintained; and
performing a second function corresponding to the detected second touch input.

2. The method of claim 1, wherein the second function is a function related to the first function.

3. The method of claim 2, wherein the first touch input is a touch event that selects at least one specific object in a home screen or a list screen, and the first function is a function of editing the home screen or the list screen.

4. The method of claim 3, wherein the second touch input is a touch movement event that is generated in the home screen or the list screen, and the second function is a function of moving the home screen or the list screen corresponding to the touch movement event while maintaining a movement of the selected at least one specific object.

5. The method of claim 4, further comprising:
when the first touch input is released, changing a location of the at least one selected specific object to a location in which the first touch input is released.

6. The method of claim 2, wherein the first touch input is a touch event that selects at least one specific page in an electronic book content execution screen, and the first function is a function of adding a bookmark to the selected specific page.

7. The method of claim 6, wherein the second touch input is a touch movement event that moves a page of an electronic book content, and the second function is a function of moving the page of the electronic book content corresponding to the touch movement event.

8. The method of claim 7, further comprising:
when the page is moved to a previous or a next page and a touch movement event of the first touch input is inputted, moving to a page to which the bookmark is added.

9. The method of claim 6, further comprising:
when the first touch input is released, removing the bookmark added to the specific page.

10. An apparatus for providing a multi touch interaction in a portable terminal, comprising:
a touch panel; and
a controller configured to perform a first function corresponding to a first touch input detected on the touch panel and configured to perform a second function corresponding to a second touch input when the second touch input is detected while the first touch input is maintained.

11. The apparatus of claim 10, wherein the second function is a function related to the first function.

12. The apparatus of claim 11, wherein the first touch input is a touch event that selects at least one specific object in a home screen or a list screen, and the first function is a function of editing the home screen or the list screen.

13. The apparatus of claim 12, wherein the second touch input is a touch movement event that is generated in the home screen or the list screen, and the second function is a function of moving the home screen or the list screen corresponding to the touch movement event while maintaining a movement of the selected at least one specific object.

14. The apparatus of claim 13, wherein, when the first touch input is released, the controller changes a location of the selected at least one specific object to a location in which the first touch input is released.

15. The apparatus of claim 11, wherein the first touch input is a touch event that selects a specific page in an electronic book content execution screen, and the first function is a function of adding a bookmark to the selected specific page.

16. The apparatus of claim 15, wherein the second touch input is a touch movement event that moves a page of an electronic book content, and the second function is a function of moving the page of the electronic book content corresponding to the touch movement event.

17. The apparatus of claim 16, wherein, when the page is moved to a previous or a next page and a touch movement event of the first touch input is inputted, the controller outputs to a page to which the bookmark is added.

18. The apparatus of claim 15, wherein, when the first touch input is released, the controller removes the bookmark added to the specific page.

19. A computer-readable storage medium encoded with instructions that, when executed, cause a device to execute the method of claim 1.
